(19) United States
(12) Patent Application Publication
(10) Pub. No.: US 2025/0224605 A1
(43) Pub. Date: Jul. 10, 2025

(54) Aperture Extender for Autocollimators and Telescopes

(71) Applicant: Oren Aharon, Haifa (IL)

(72) Inventor: Oren Aharon, Haifa (IL)

(21) Appl. No.: 18/406,158

(22) Filed: Jan. 7, 2024

(51) Int. Cl. G02B 23/02; G02B 5/04

(52) U.S. Cl. CPC G02B 23/02; G02B 5/04

(57) ABSTRACT

The disclosure introduces a technique to expand the aperture of an optical system like an Autocollimator by interconnecting two or more rhomboidal prisms in a sequential manner. This method involves securing the initial rhomboid to the autocollimator's aperture using a rotating component at its base. Subsequently, a second rotating component is attached to the exit end of the first rhomboid, enabling individual rotation for both rhomboids. These prisms are coated with distinct partial mirror coatings. The processing of the reflected image from these rhomboids are conducted to ascertain the deviation in the line of sight caused by their presence and positioning. A microprocessor computes the measurement of the back reflected beams concerning the rhomboids' positions, determining beam deviations resulting from imperfections in the manufacturing of the rhomboids. The identified imperfections are employed to rectify the outcomes derived from the assembly of rhomboids, ensuring heightened precision in the collected data.

### BACKGROUND OF THE INVENTION

### 1. Field of Invention

The current invention pertains to an apparatus designed for capturing optical information external to a specified instrument aperture. This apparatus redirects the gathered information without compromising the parallelism or optical characteristics of the instrument's aperture.

### 2. Description of the Related Art

In optical applications, achieving precise inter-alignment and bore sighting among multiple devices positioned at offsets presents a significant challenge. Conventionally, employing an autocollimator capable of encompassing all device apertures is considered an ideal solution. However, this approach often proves prohibitively expensive and, in many cases, unfeasible due to substantial distances between the devices.

In instances where the separation between the optical devices to be aligned is smaller than the autocollimator's aperture, a viable method involves utilizing the autocollimator to project a reference cross. This projected reference cross facilitates alignment by analyzing the disparities between its observed images in the optical devices slated for alignment. Another approach involves reflecting the projected image from these devices and utilizing built-in software, commonly found in autocollimators, to assess and quantify the deviation between the two optical devices.

These methodologies offer efficient means of achieving alignment and bore sighting in scenarios where traditional autocollimation techniques encounter limitations imposed by large distances or cost constraints.

### SUMMARY

The present invention addresses the challenge of testing the alignment of optical devices situated in close proximity, beyond the scope of conventional autocollimators or telescopic devices due to their limited optical aperture. This innovation proposes a solution by integrating multiple optical prismatic elements, particularly rhomboidal prisms, which, upon unfolding, expand the autocollimator's aperture to encompass all the devices under test. The objectives and advantages of this invention will be elucidated through the description of various embodiments.

In one embodiment, a pivotal aspect of this invention involves two rhomboidal elements. The first rhomboidal element houses a central axis of rotation aligned with the autocollimator's center, while the second rhomboidal element features an axis of rotation positioned at the output end of the first rhomboidal element. Precision manufacturing of these rhomboidal elements poses a challenge; however, their rotational movement with respect to each other significantly widens the covered aperture, surpassing the initial limits of the autocollimator's aperture.

Furthermore, the autocollimator, by monitoring back reflections from the surfaces of the rhomboidal prisms, can assess and correct any inaccuracies present within the prisms. This correction involves utilizing the measured inaccuracies to align the back-reflected information, aided by an autocollimator capable of projecting a reference cross at multiple wavelengths, simplifying the computation of rhomboidal inaccuracies. It should be evident to a professional that the same concept could be expanded to involve a serial connection of rhomboids, surpassing the two rhomboids already described.

Enhancing the device's functionality involves eliminating inter-reflections occurring between the optical surfaces of the rhomboidal elements. To achieve this, an innovative approach integrates an index matching gel or fluid between the rhomboids, nullifying the refractive index discrepancies between the elements and the surrounding air. The design of said index matching gel or fluid allows a relative movement between rhomboids while preserving index matching features.

By introducing these advancements, the invention aims to revolutionize alignment testing for closely situated optical devices, overcoming the limitations of traditional autocollimators and ensuring precise alignment through expanded aperture coverage and error correction mechanisms.

To summarize, the innovation discloses an aperture extender system for optical devices, comprising interconnected rhomboidal prisms configured to widen the aperture of an autocollimator or telescope beyond its original limits.

The rhomboidal prisms are secured to the autocollimator's aperture using rotating components allowing individual rotation for each rhomboid.

A method for assessing and correcting inaccuracies in rhomboidal prisms integrated into an aperture extender system, utilizing partial mirror coatings, microprocessor computation, and index matching gel or fluid to eliminate inter-reflections between rhomboidal surfaces. An application of the aperture extender system involving inter-rotation among rhomboids, demonstrating flexibility in covering a substantial input/output aperture beyond the original scope of the autocollimator.

Further comprising a penta-prism attachment enabling manipulation of the original optical axis of the autocollimator in combination with rotating rhomboids for enhanced flexibility and angle manipulation.

A method for aperture extender system for optical devices involving the following steps: interconnecting rhomboidal prisms, securing the initial rhomboid to the autocollimator's aperture using a rotating component at its base, attaching a second rotating component to the exit end of the first rhomboid, enabling individual rotation for both rhomboids, utilizing distinct partial mirror coatings on the rhomboids and process reflected images to assess the deviation in the line of sight caused by their positioning, and employing a microprocessor to compute the measurement of back-reflected beams concerning the rhomboids' positions, detecting imperfections in the rhomboids' manufacturing.

### BRIEF DESCRIPTION OF THE DRAWINGS

FIG. 1 is a perspective view of the problematic setup of prior art when alignment of elements outside of the autocollimator's aperture are needed.

FIG. 2 is a perspective view of an Autocollimator equipped with two rhomboidal prisms rotating one in the center of the Autocollimator's aperture, and the second rotating around the center of the output of first rhomboid.

FIG. 3 is a depiction image of the mechanical layout of two rotating rhomboids.

FIG. 4 is a serial setup showing more than two rhomboids connected together.

FIG. 5 is an image showing the rhomboid prismatic elements rotated in respect to each other and creating a larger encompassed area when compared to the original Autocollimator's aperture.

FIG. 6 is yet another embodiment showing the rhomboidal prismatic element attached to another prismatic element in such a way that the prismatic element reflects the output from the Autocollimator at a different angle which is further manipulated by said rotating rhomboids.

### DETAILED DESCRIPTION OF THE INVENTION

Rhomboid prisms are constructed in the shape of a parallelogram to displace a light beam or the line of sight without affecting the orientation of the image. The prisms have two smaller parallel reflecting surfaces (legs) that are cut at a 45-degree angle to a much longer rectangular-shaped body. A variety of additional prism designs have unique properties, primarily image erecting and inversion, which enable them to perform specific functions which may be attached to my rhomboids to create capability of not only expanding the original aperture but also to change its initial orientation.

For better understanding of the disclosed art a short description of classical autocollimators is needed (although the technology is applicable to laser beam or other light sources). For creating the effect of autocollimation a light source projects a cross which is imprinted on a reticle. The projected image passes through the beam splitter and further projected by an objective lens exiting the autocollimator's body through an aperture. Usually, the objective collimated the exiting projected cross.

Collimation means that the projected reticle is exactly one focal length away from the main surface of the objective lens. The projected collimated light is back reflected by a mirror, or other high-quality reflective surface, and is captured by the aperture of said objective lens. The returned image appears in sharp focus on the high-quality CCD detector. Due to the detector high sensitivity even very faint back reflection will be captured and displayed.

Deviation of the mirror by an amount A is causing deviation on the original line of sight by an amount of 2A. Assuming the amount of deviation of the reflective surface the focal length is denoted by FL, then mirrors' deviation is to be determined from the relationship: A=X/2FL

From the equation it is apparent that measuring mirror angular deviation is independent of the distance between the instrument and the reflecting surface. Deviations in azimuth and elevation can then be electronically determined and calculated by a computer. Furthermore, the results are than clearly displayed on its screen. Resolution down to 0.01 arcsec is achievable.

As a rule of thumb, the higher the FL—the higher the resolution. As a result, the field of view is smaller and thus it is more difficult to acquire the reflected signal acquisition.

The electronic method offers the advantage of complete objectivity in data recording, as well as a computer interface unlike optical autocollimators which are bulkier and less accurate.

In a telescopic application, where the telescope is calibrated to infinity, the angle of movement is A=X/FL.

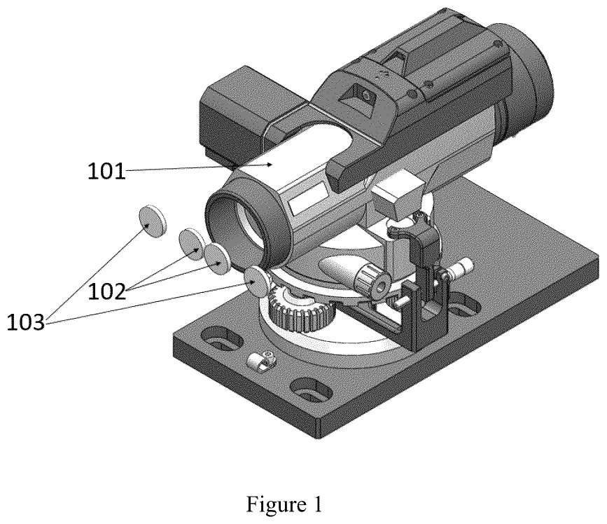

FIG. 1 visually demonstrates the constraints associated with a finite aperture system. The Autocollimator 101 possesses a specific aperture size through which it projects a cross. When two mirrors, identified as 102, fall within the confines of this aperture, the autocollimator captures the back reflections from these mirrors, enabling the acquisition and display of their respective angles. Conversely, if two mirrors, designated as 103, exist outside the autocollimator's aperture and are positioned in front of the device, no reflections are generated. As a result, in current technological setups, the angle positions of these mirrors remain undetermined and cannot be ascertained.

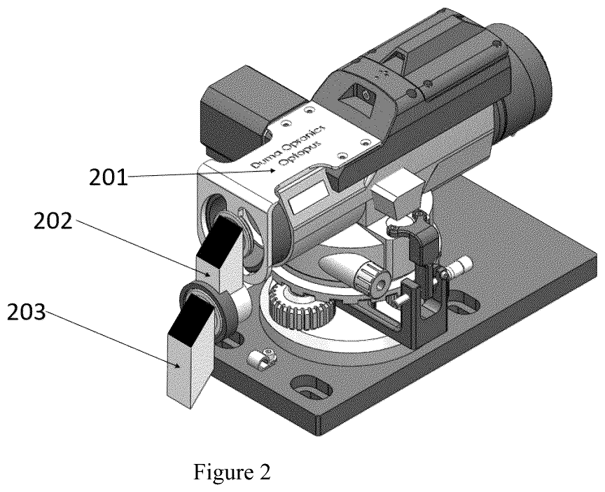

In FIG. 2, the depicted autocollimator, akin to that in FIG. 1, includes a mechanical attachment marked as 201. This attachment accommodates mounted rhomboidal elements arranged in a manner where the first rhomboid, denoted as 202, executes a rotational movement of its input face around the center of the autocollimator's aperture. Additionally, rhomboid 203, affixed to the exit surface of rhomboid 202, possesses the capability to rotate around the center of the output surface of rhomboid 202. These two rotational degrees of freedom enable the positioning of the output surface of rhomboid 203 at various locations within a circumference determined by the combined length of both rhomboidal elements. Consequently, this configuration expands the aperture, allowing the reception and transmission of input/output information from an area significantly larger than the original autocollimator's aperture.

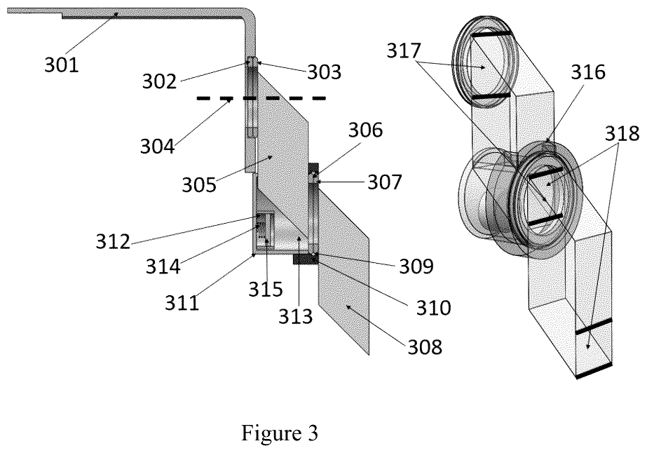

In FIG. 3, the arrangement showcases two interconnected rhomboids capable of independent rotation in relation to each other. The rotation occurs at the exit of one rhomboid and the input of the second. Notably, the first rhomboid's input is positioned at the optical axis of an optical autocollimator and is free to rotate concentrically around this axis. The elements in this arrangement include:

301: A mechanical attachment linking the autocollimator to the rhomboidal layout, 302 and 303: Bearing devices composed of two annular magnets connected by magnetic force, allowing rotational movement, 304: Represents the optical axis of the autocollimator and the center of rotation for the magnetic bearing, 305: The first rhomboidal attachment with an input area facing the autocollimator's aperture, capable of rotating around the optical axis 304. 306 and 307: Similar magnetic bearings enabling rotation between the output of the first rhomboid and the input of the second rhomboid 308. 309: A ring sealing mechanism between the magnetic bearing facets, preventing leaks of fluids or gels from the cavity formed by the distance between the rhomboids' facets, 310: Housing for the magnetic bearing connection of the two rhomboids, 311: A small reservoir containing index-matching liquid 313 or gel, filling the gap between the output facet of the first rhomboid and the input facet of the second rhomboid. This filler is pressurized by cylinder 312 to counteract potential leaks, ensuring prolonged device lifespan. The pressure effect is achieved by a spring device 314 applying force on a piston-like 315.

For measuring angular deviations due to rhomboid inaccuracies, special coatings can be applied to the input and output facets of each rhomboid. These coatings cause partial reflection of the cross projected by the autocollimator through the rhomboid, allowing the autocollimator to measure these inaccuracies. To distinguish between the first and second rhomboids, different coatings such as dichroic coatings can be utilized, causing each rhomboid to reflect different wavelengths based on its coating. The autocollimator identifies back reflections by their colors, employing a color camera or projecting crosses of different colors. 317 and 318 represent coatings on the first and second rhomboids, respectively. 316 signifies the adhesive area between the rhomboid and the bearing housing 310.

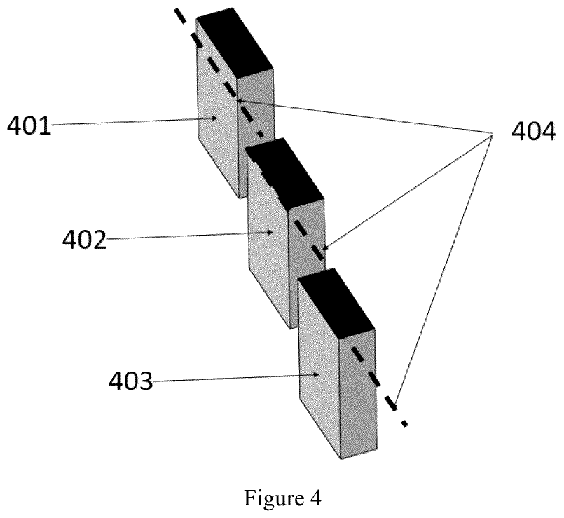

FIG. 4 illustrates a potential serial linkage of rhomboids, surpassing a two-rhomboid connection as disclosed, to establish an extended and highly flexible rhomboidal attachment. Rhomboids labeled as 401, 402, and 403 are depicted within this configuration. Each rhomboid is identified by its respective rotation axis, designated as 404.

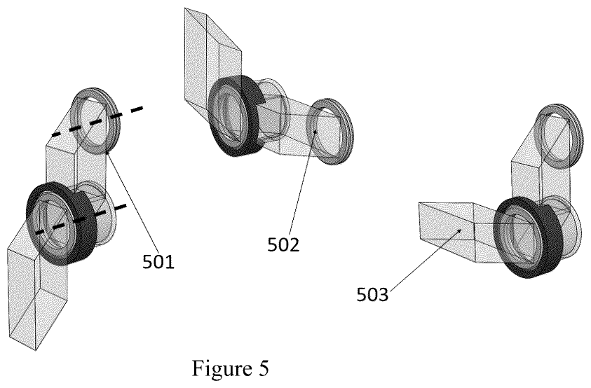

FIG. 5 presents a demonstrative representation of the inter-rotation among rhomboids in relation to one another. Specifically, depiction 501 showcases a scenario of zero rotation, while illustration 502 portrays rotation around both rotational axes. Additionally, FIG. 503 illustrates rotation around a singular axis, effectively highlighting the system's flexibility in covering a substantial input/output aperture.

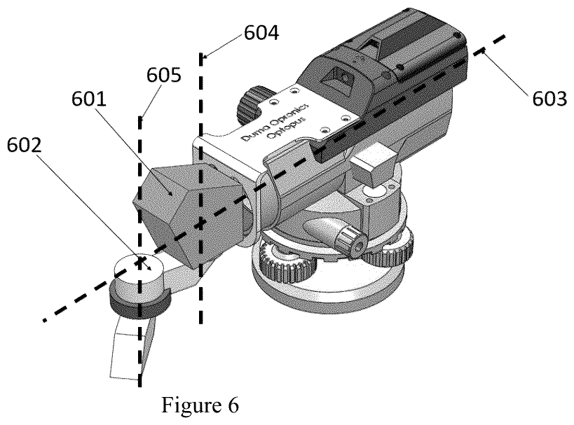

FIG. 6 displays an alternative application wherein the original optical axis of the autocollimator undergoes a 90-degree deflection through the utilization of a designated penta-prism, identified as 601. Two rhomboidal systems, akin to the disclosed arrangement within this invention, are linked to the mentioned penta-prism, labeled as 602. These systems possess the capability to rotate around axes 604 and 605. The initial autocollimator's line of sight is indicated by reference numeral 603.

1. An aperture extender system for optical devices, comprising interconnected rhomboidal prisms configured to widen the aperture of an autocollimator or telescope beyond its original limits.

2. The system of claim 1, wherein the rhomboidal prisms are secured to the autocollimator's aperture using rotating components allowing individual rotation for each rhomboid.

3. A method for assessing and correcting inaccuracies in rhomboidal prisms integrated into an aperture extender system, utilizing partial mirror coatings, microprocessor computation, and index matching gel or fluid to eliminate inter-reflections between rhomboidal surfaces.

4. An application of the aperture extender system involving inter-rotation among rhomboids, demonstrating flexibility in covering a substantial input/output aperture beyond the original scope of the autocollimator.

5. The system of claim 1, further comprising a penta-prism attachment enabling manipulation of the original optical axis of the autocollimator in combination with rotating rhomboids for enhanced flexibility and angle manipulation.

6. A method for aperture extender system for optical devices involving the following steps:
interconnecting Rhomboidal Prisms;
securing the initial rhomboid to the autocollimator's aperture using a rotating component at its base;
attaching a second rotating component to the exit end of the first rhomboid, enabling individual rotation for both rhomboids;
utilizing distinct partial mirror coatings on the rhomboids and process reflected images to assess the deviation in the line of sight caused by their positioning; and
employing a microprocessor to compute the measurement of back-reflected beams concerning the rhomboids' positions, detecting imperfections in the rhomboids' manufacturing.
